(19) United States
(12) Patent Application Publication
(10) Pub. No.: US 2014/0032912 A1
(43) Pub. Date: Jan. 30, 2014

(54) TRUST CONTEXT FOR DOCUMENT SIGNATURES

(71) Applicants: Matthew Hardy, Sunnyvale, CA (US); Jeremy Seeba, San Jose, CA (US)

(72) Inventors: Matthew Hardy, Sunnyvale, CA (US); Jeremy Seeba, San Jose, CA (US)

(73) Assignee: Adobe Systems Incorporated, San Jose, CA (US)

(21) Appl. No.: 12/431,642

(22) Filed: Apr. 28, 2009

(51) Int. Cl. H04L 9/00

(52) U.S. Cl. 713/176

(57) ABSTRACT

Apparatus, systems, and methods may operate to access electronic content comprising a document file including document content data, digital signature data, and digital signature trust context data including a previously-stored version number. Additional activities may include executing instructions included in a document processing application to access the digital signature trust context data and to obtain a trusted version number from a digital signature trust settings file, comparing the trusted version number with the previously-stored version number, and indicating the previously-stored version number is not current when the previously-stored version number is not greater than or equal to the trusted version number. Additional apparatus, systems, and methods are disclosed.

### BACKGROUND

Various document processing application programs, such as the MICROSOFT® Office or ADOBE® ACROBAT® programs, provide the ability to digitally sign documents. In most cases, by default, only certificates that chain to the manufacturer's root certificate authority are trusted for digital signatures. To enable trust for other certificates and root authorities means engaging in a manual process.

More recently, the capability has been added within some programs to distribute certificates and trust settings through a security settings file. While these security settings can be electronically communicated, there is no provision to indicate whether the security settings for a given digital signature have changed. Given that the standard period for checking such changes may be on the order of months, security settings for a particular document may be out of date for long periods of time. Further, companies which provide updated security settings may have no easy way to inform the user that updated settings are available.

### BRIEF DESCRIPTION OF THE DRAWINGS

Some embodiments are illustrated by way of example, and not limitation, in the figures of the accompanying drawings, in which:

FIG. 1 illustrates a document and a document file, according to various embodiments.

FIG. 2 is a flow diagram illustrating several methods according to various embodiments.

FIG. 3 is a flow diagram illustrating several additional methods according to various embodiments.

FIG. 4 is a block diagram of apparatus and systems according to various embodiments.

FIG. 5 is a block diagram of an article of manufacture, including a specific machine, according to various embodiments.

### DETAILED DESCRIPTION

Various embodiments may operate to embed ancillary information into a digitally signed document so that additional or updated information, used for verification, can be obtained automatically. In this way, certificates not available in the original application installation, perhaps required by a given digital signature to successfully validate, can be obtained without user intervention.

In many embodiments, there are two parts to the process: storing a trust context in the document, where the trust context includes directions that point to a trust settings file; and accessing the trust context at some later time to locate the trust settings file and to verify that a version number of the trust settings file stored in the document (at the time the document was signed) is current. A hash of the certificate used to sign the trust settings file is also stored in the document. Thus, all three pieces of information (directions, version number, and hash) are embedded within the document and signed as part of affixing a signature to the document. In this way, tampering with any one of the embedded elements serves to invalidate the signature.

For the purposes of this document, the term “electronic content” includes any digital data that may be presented to a user (e.g., visually or audibly presented), such as an electronic document, page descriptive electronic content such as a page descriptive format electronic document, a media stream, a web page, a hypertext document, an image, digital video or a video recording, digital audio or an audio recording, animation, a markup language document, such as a HyperText Markup Language (HTML) or eXtensible Markup Language (XML) document, a form having blank components to accept entered data, or data describing the application of a GUI.

A “content element” includes any part of electronic content that is defined or discernable as a part. For example, a content element may be automatically discerned from a characteristic of the content element itself (e.g., a paragraph of an electronic document, or a file format designation) or may be manually defined by a user (e.g., a user-selected collection of symbols or words in an electronic document, a reviewer-selected portion of a digital image). Examples of content elements include portions of a page descriptive format document or other electronic document, such as pieces of electronic text or other material within an electronic document, comments, dynamic content in the form of portions of media streams, such as sections of digital video or frames or sets of frames of digital video or digital audio, dynamic content in the form of segments or frames of animations, electronic forms, form templates, form elements, form data, actuatable element specifications or executable instructions, and various elements presentable or accessible by reviewers within electronic content, including instances of scripted and non-scripted dynamic content and the like.

A “page description language” uses a page descriptive format to describe how type and graphic elements should be produced by output devices, such as a description of the appearance of a printed page. Typically, a page descriptive format makes use of textual or binary data streams that operate at a level that is higher than an output bitmap. Examples of a page description language include that which is processed by a Postscript® interpreter, XPS (XML Paper Specification), and other languages that format documents according to a page descriptive format, including a portable document format, among others.

A “portable document format” means a device-independent and display resolution-independent fixed-layout document format, including the text and fonts, images, and graphic paths associated with the document. The format may comprise a representation of a two-dimensional document, or a three-dimensional document. An example of a commercially available portable document format (*.pdf) is the format described in “PDF Reference”, sixth edition, ADOBE® Portable Document Format, Version 1.7, November 2006.

The term “rendering” used as a verb includes presenting or making accessible electronic content or content elements to be perceived, viewed, or otherwise experienced by a user, or made available for further processing, such as, for example, searching, digesting, printing, analyzing, distilling, or transforming by computational processes that may not include processing the intrinsic data structure describing the electronic content or content element.

The term “rendering” used as a noun includes human-perceivable representations of data that is within a machine and perception-specialized organizations of data defining such representations. For example, a rendering may include a pattern of human-perceivable matter or energy presented on an output device (e.g., a printer or display) by a machine, as well as the organization of data within a machine that defines such patterns. For example, such organizations of data may include the electronic configuration of a memory used by a graphics display processor, or a file containing an audio segment suitable for playing via an audio system of a computer.

The term “rendering module” may be taken to include systems, applications, and mechanisms for rendering or presenting electronic content to a user, including the presentation of content elements such as text, graphics, form element renderings, and other electronic content elements. An example of a rendering module includes a web browser component (e.g., MICROSOFT® Internet Explorer) or other component to render electronic content such as HTML pages. Another example of a rendering module includes the ADOBE® ACROBAT® electronic publishing program.

The term “rendering program” includes applications for rendering or presenting dynamic content to a reviewer. An example of a rendering program is the ADOBE® FLASH® Player 9 runtime software application. In many embodiments, a rendering module interacts with a rendering program to render dynamic content.

A “trust context” is a group of settings, including directions to a trust settings file and a revision number of the trust settings file, which uniquely identify the trust settings for a particular digital signature.

A signature is “trusted” when there is a confirmed chain of trust from that signature back to a trusted root certificate authority.

A signature is “valid” when the coded (e.g., hashed) version of a document digest produced when the document was signed matches that reproduced when the same coding algorithm is applied to the same document at a later time.

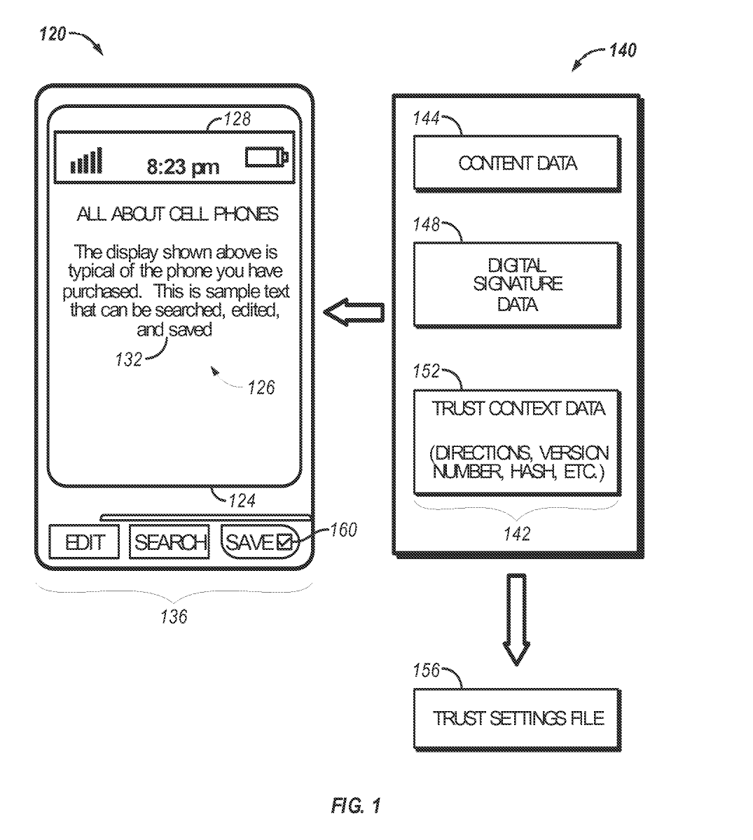

FIG. 1 illustrates a document 126 and a document file 140, according to various embodiments. For example, a device 120 may be used to display a document 126 comprising graphics 128 and text 132 on a display 124. The device 120 may comprise a tablet computer, a cellular telephone, a workstation, or any other device that has a display 124 capable of presenting a visible representation of the document 126 and graphics 128. The text 132 can be searched, edited, and saved using a keypad 136. The document 126 is rendered on the display 124 using a document processing application program, such as the ADOBE® ACROBAT® program or the Microsoft® Word program. Rendering typically occurs once the document file 140 is accessed by the document processing application program.

The document file 140 comprises multiple elements 142, including content data 144 that describes the content and layout of the graphics 128 and text 132 in the document 126. The document file 140 also comprises digital signature data 148 and trust context data 152. As noted previously, the trust context data 152 comprises directions pointing to the trust settings file 156, a version number of the trust settings file at the time the document 126 was signed, and a hash or digest of the document content data 144. The trust settings file 156 is distinct from, and therefore does not form a part of the document file 140. The hash may result from applying a secure hash algorithm (e.g., SHA-1) to the public certificate corresponding to the certifier of the trust settings file.

By embedding the trust context data 152 within a document, information is now readily available each time the document file 140 is accessed with respect to how the latest trust settings can be obtained, and whether an update is required. The trust context data 152 may potentially comprise multiple security contexts, one for each document signature.

The trust settings file 156 may include specifications as to which certificates are to be trusted, and the chain of trust that should be used to reach a trusted root certificate. Here it can be seen that it is useful to implement the trust context data 152 in a way that automatically provides access to current trust settings file 156 in a trustworthy manner. In some embodiments, for example, the trust context data 152 includes a uniform resource locator (URL) that can be used as a path to locate the trust settings file 156.

In certain embodiments, digital signatures include the revision number of the trust settings that are used to validate the signatures. The module (e.g., application program or hardware) validating the digital signature can use the version number previously stored in the document to determine whether the current revision of information specified by the trust settings have been installed in the device 120 and, if not, the module can operate to obtain the current (e.g., newer) settings using the trust context data 152 embedded in the corresponding document file 140.

Thus, in some embodiments, the trust context data 152 stored in the document file 140 is associated with a version number. The device 120 may include a trust settings file 156 (which may also be located elsewhere, such as on a server, or in a remote storage unit) that is also associated with a version number, indicating the settings that are installed on the device 120. If the version number previously stored inside the document file 140 is less than the version number stored in the settings file 156 on the device 120, then the device may need to perform an update of various components. Version numbers may comprise alphabetic characters, numeric characters, and combinations of these, including a time and/or date.

In some embodiments, a specific version may be noted in the trust context data 152. For example, a customer base of annual subscribers to a software service may be instructed to use a certificate that is valid for a particular year, but not for prior or subsequent years. Thus, instead of the version number stored in the document file 140 comprising a “minimum version’, the version number may comprise an “exact version”.

When a document author digitally signs a document 126, he may be given the option of embedding the trust context in the document 126. The elements of the trust context data 152 can then be automatically obtained from related application settings (e.g., a security settings URL can be designated in the document security preferences) or the author can specify the location of the appropriate trust settings file 156, so that the trust context can be constructed with an embedded version number.

Since the trust context data 152 contains the directions for locating the trust settings file 156, the user now has automatic access to the most current security settings. Using the trust setting file 156, more extensive signature verification mechanisms (e.g. timestamps and revocation information) can also be stored remotely, so that a signed document does not need to embed large amounts of security information, potentially reducing the size of the secure document file 140.

When a document file 140 with embedded trust context data 152 is opened, the document processing application can operate to check the information found in the trust context data 152 against currently-installed security settings files. If a file specified by the trust settings file 156 is not found, or if the version specified by the trust settings file 156 is found to be more recent than what has been stored as part of the trust context data 152 of the document 140, then the user can be notified of the need for an update.

Thus, in some embodiments, document processing applications and/or devices 120 may include a check-box 160 that specifies the trust context data is to be embedded in the document. Thus, when the user elects to sign the document, the internal settings can be automatically obtained thereafter for constructing the trust context data 152. Therefore, many embodiments may be realized.

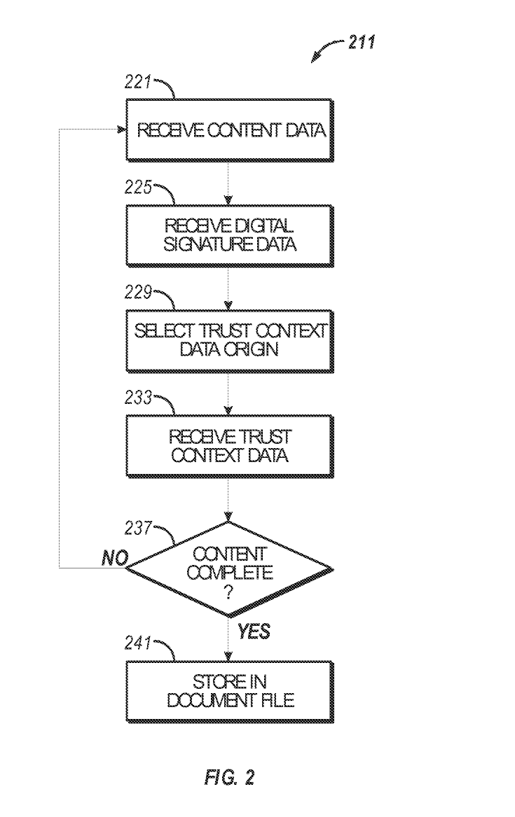

For example, FIG. 2 is a flow diagram illustrating several methods 211 according to various embodiments. In some embodiments, a computer-implemented method 211 of creating a document may begin at block 221 with receiving document content data, for example, document content data comprising text, graphics, and formatting information. The method 211 may continue on to block 225 with receiving digital signature data, which may comprise the full public certificate.

In some embodiments, the method 211 may continue on to block 229 with selecting the origin of the trust context data. For example, the digital signature trust context data may be predefined and stored, or entered on-the-fly at a graphical user interface (GUI), by a user. Thus, the activity at block 229 may comprise, prior to storing the document, selecting between obtaining the digital signature trust context data as defined in a file, or obtaining the digital signature trust context data as received from a GUI.

The method 211 may continue on to block 233 with receiving digital signature trust context data. As noted previously, the digital signature trust context data may include a number of elements. For example, the digital signature trust context data may indicate where to locate the digital signature trust settings file. Thus, the digital signature trust context data may comprise directions to locate a digital signature trust settings file, perhaps in the form of a URL.

The digital signature trust context data may also include a version number, which is fixed in the document at the time the document is signed. For example, the document file may comprise a *.pdf representation of the document. The signature is calculated on the data within the *.pdf format file (e.g., the document content data) and then stored within the document. Thus, the digital signature trust context data may comprise the version number of a trust settings file existing at the time of signing the document file.

The digital signature trust context data may also comprise a signed hash/digest of the document. For example, signing the hash/digest may comprise performing a mathematical computation using the private component of a user's credential/certificate, as is well known to those of ordinary skill in the art.

It should be noted that in signature terms, a “certificate” refers to the public part of a credential and the “private key” refers to the private part of the credential—only the public certificate is given out and the private part is kept secure. When verifying that a document has not been altered, another hash can be made of the document to compare against the hash stored within the signature. The stored hash is produced by applying the public certificate to the signed hash. If the second hash of the document matches the stored hash, then the documents is unchanged.

The method 211 may continue on to block 237, with determining whether the document content is complete, or whether more is to be added, changed, or deleted. If the document is not complete, then the method 211 may include returning to block 221, where additional content is acquired.

Once it is determined that the content of the document is complete (e.g., a request to save the document is received), the method 211 may comprise generating a digital signature to use in signing the document file prior to storing various elements in the document file at block 241. Thus, if the content of the document is determined to be complete at block 237, the method 211 may also continue on to block 241 with storing the document content data, the digital signature data, and the digital signature trust context data in the document file, which can later be accessed by a document processing application.

A SHA-1 hash (or a hash provided by any other hash algorithm) of the public certificate which corresponds to the private credential used to sign the hosted trust settings file can be stored inside the document file, along with the URL, etc. of the public certificate corresponding to the private credential used to sign the hosted trust settings file. The entire public certificate corresponding to the private credential used to sign the document can also stored in the document, as part of the practice of creating a digital signature. Thus, the activity at block 241 may comprise storing the digital signature data as a hash of a public certificate used to sign the document file.

The document file may be originally formatted according to a page descriptive format, including a portable document format, such as a *.pdf format file compatible with the ADOBE® ACROBAT® program. Of course, the document file may be created in other formats and stored in those formats, or even converted to a portable document format prior to be signed in some embodiments. Thus, the document file may comprise one or more of a word processing document file, a presentation document file, or a spreadsheet document file, among others.

It should be noted that a single document may include multiple security contexts, each corresponding to a separate signature that has been applied to the document. Thus, the document file may comprise a plurality of security contexts corresponding to a plurality of digital signatures. Still further embodiments may be realized.

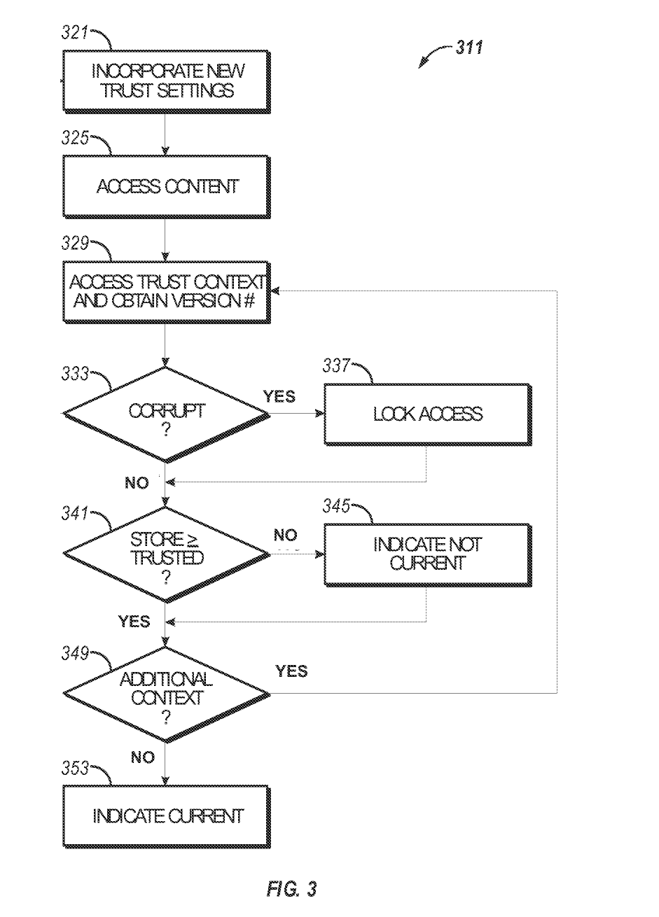

For example, FIG. 3 is a flow diagram illustrating several additional methods 311 according to various embodiments. The methods 311 may include processing a document to access the document, determine the version number included in the digital signature trust settings file, and compare the version number to the version number included in the document's digital signature trust context data to determine whether the previously-stored version number (the version number included in the document) is older than what is currently indicated to be trusted by the trust settings file.

Thus, a computer-implemented method 311 of accessing a signed document may begin at block 321 with incorporating new trust settings into the trust settings file and/or the trust context. For example, the trust settings file information can be updated on a periodic basis, such as when a third party desires to be included as a trusted party within the trusted context. Thus, the activity at block 321 may include receiving new trust settings information from a third party, and incorporating the new trust settings information in the digital signature trust settings file. Alternatively, or in addition, the digital signature trust context data, such as a URL pointing to the trust settings file, can be received from a GUI. Thus, the activity at block 321 may comprise receiving at least some of the digital signature trust context data from a GUI.

The method 311 may continue on to block 325 with accessing electronic content, perhaps comprising a document file that includes document content data, digital signature data, and digital signature trust context data. Common documents to be accessed include word processing documents, presentations, and spreadsheets. Thus, the activity at block 325 may include opening a document file using a document processing application comprising one or more of a word processing application, a presentation processing application, or a spreadsheet processing application, among others.

The method 311 may further comprise executing instructions included in a document processing application to access the digital signature trust context data at block 329, for example, to obtain a trusted version number from a digital signature trust settings file.

Some or all of the digital signature trust context data may be encoded, perhaps as a hash. Thus, decoding may be used to access various components, such as the previously-stored version number. Therefore, the activity at block 329 may comprise decoding the previously-stored version number using a public key. The digital signature trust context data can be accessed locally, without recourse to a network, as it is stored in the document. Thus, the activity at block 329 may also comprise executing the instructions in the document independently of coupling the current processing entity to a network.

If any of the digital signature trust context data is corrupt, then tampering may have occurred with respect to the digital signature. Thus, the method 311 may continue on to block 333 in some embodiments with determining that the digital signature trust context data has been corrupted. If the trust context data is corrupt, as determined at block 333, then the method 311 may comprise prohibiting access to the document file at block 337. For example, the activity at block 337 may include selectively locking access to the document file when the digital signature trust context data has been corrupted.

The method 311 may continue on to comparing the trusted version number with a previously-stored version number included in the digital signature trust context data at block 341. When the previously-stored version number is not greater than or equal to the trusted version number, the method 311 may include indicating the previously-stored version number is not current at block 345.

The activity of indicating at block 345 may include indicating using an electronic display, such as a cathode ray tube (CRT), flat screen light emitting diode, or other electronic display technologies. Indicating may even occur using electrophoretic film (or paper) that is also sometimes referred to as e-paper, digital paper, electronic ink, or digital ink and is commercially available from such companies as E Ink Corporation of Cambridge, Mass. and Magink Display Technologies, Inc. of San Bruno, Calif.

In some cases, it may be desirable that a specific trust context is used, and no other, such as may occur with subscribers to an annual software update service. Thus, the activity at block 345 may include indicating the previously-stored version number is not current when the previously-stored version number is not exactly equal to the trusted version number.

In some document management contexts, it may be desirable to lock access to the document file when the access attempt indicates the stored version number is not current. Thus, the activity at block 345 may also comprise publishing an error message, and locking access to the document file.

Multiple signatures included in a document may be verified using the same mechanism as for a single signature. Thus, the method 311 may continue on to block 349 with determining whether additional trust contexts are embedded in the document file. This activity may include verifying trust for a plurality of digital signatures applied to the document file, wherein the plurality of digital signatures correspond to a plurality of security contexts. The additional information can be accessed and processed by returning to block 329, and those that follow it. Otherwise, the method 311 may proceed on to block 353 with indicating that the trust settings used on the processing device with respect to the document file are current, according to the information available from the trust settings file.

It should be noted that the methods described herein do not have to be executed in the order described, or in any particular order. Moreover, various activities described with respect to the methods identified herein can be executed in iterative, repetitive, serial, or parallel fashion. Activities within various methods may also be combined, to include combination across the various figures used herein. Information, including parameters, commands, operands, and other data, can be sent and received in the form of one or more carrier waves.

It should also be noted that in every case where the activity of displaying or rendering is denoted, information may be communicated (e.g., transmitted and received) between a variety of entities to enable such display or rendering activity. For example, a server may transmit information to a receiving entity, such as one or more clients or workstations, to enable displaying or rendering the various visual elements described. Further embodiments may be realized.

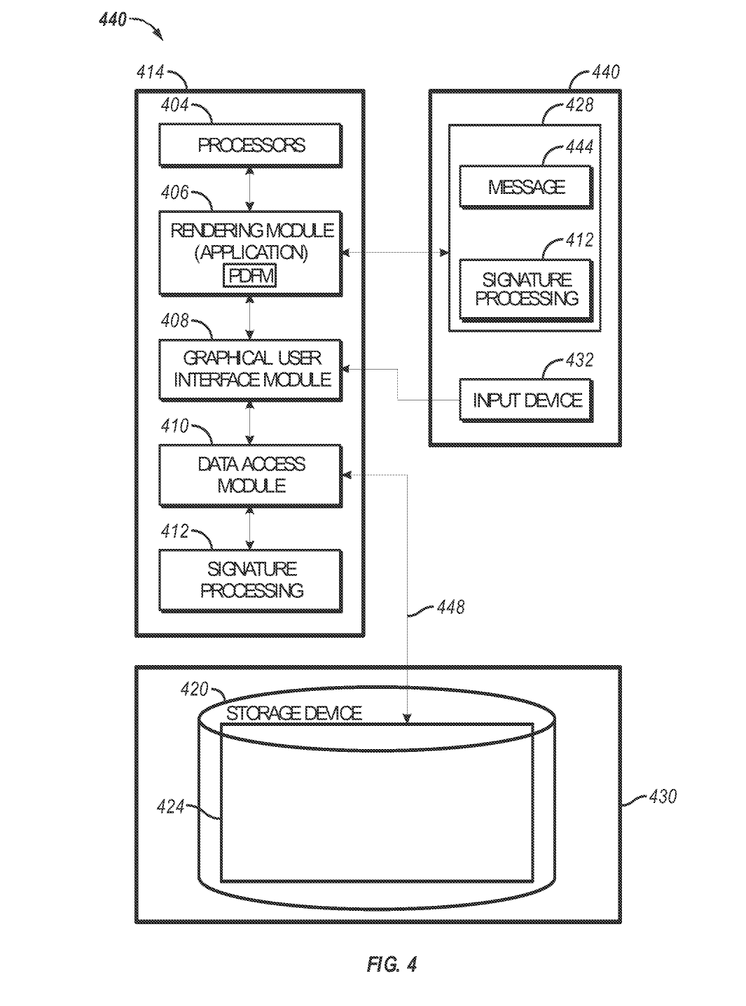

For example, FIG. 4 is a block diagram of apparatus 430, 440 and systems 400 according to various embodiments. A system 400 may include several apparatus 430, 440 and a number of modules, such as one or more processors 404, a rendering module 406 (e.g., comprising a document processing program application), a GUI module 408, a data access module 410, and a signature processing module 412. The rendering module 406 and the GUI module 408 may take the form of separate modules, as shown, or exist as an integral module. The various modules may be associated within a machine 414, perhaps comprising a personal digital assistant (PDA), cellular telephone, a laptop computer, a tablet computer, a personal computer, a workstation, or a server device. Thus, the machine 414 may be similar to or identical to the device 120 of FIG. 1.

In order to avoid obscuring the components of FIG. 4, connecting lines between each of the elements within the machine 414 have not been shown. However, those of ordinary skill in the art will understand that any of the individual elements shown to be located within the confines of the machine 414 may be operably coupled to any other element within the machine 414. Similarly, those of ordinary skill in the art will understand that any of the components shown to be located within the confines of the machine 414 may also be located outside the machine 414, and appropriately coupled to the machine 414 via wired or wireless networks or other interface mechanisms.

The data access module 410 may be used by the rendering module 406 and the signature processing module 412 to access a storage device 420, such as a database, a memory, a disk, or other storage device. The storage device 420 may serve to contain one or more items of electronic content 424. The data access module 410 may operate to read from and/or write to the electronic content 424 and may provide reading and writing services for the benefit of other system modules, including the GUI 408, the processors 404, the rendering module 406, and the signature processing module 412. The electronic content 424 may comprise one or more content elements, such as document processing application programs, and trust settings files.

The electronic content 424 may also comprise a document file, such as a word processing document, text, drawings, a data file, a spreadsheet, audio recordings, video recordings, multimedia presentations, and other types of content. Documents may be organized according to a page descriptive format, which includes a portable document format. Many other embodiments may be realized.

The data access module 410 may be present in some embodiments, and absent in others. When present, the data access module 410 may operate as a mediator between the various components of the system 400 and the electronic content 424. For example, the storage device 420 may be included in an apparatus 430 taking the form of a remote server.

The rendering module 406 may be operably coupled to an apparatus 440, such as a desktop computer or a client device including an output device 428, such as a display screen, a printer, or a loudspeaker, among others. This output device 428 may be used for communicating content elements and messages 444 via wired/wireless transmission, and/or by presenting renderings of the content elements. Thus, rendering may take the form of displaying the content data 144 shown in FIG. 1.

A GUI module 408 may be operably connected to the rendering module 406 and the data access module 410. The rendering module 406 may comprise a page descriptive format processing program, including a portable document format processing program in some embodiments.

The GUI module 408 may receive input from input devices 432 (e.g., a keyboard, a mouse, a trackball, voice recognizer, touch pad, touch screen, etc.), including user input comprising a selection of whether trust context data should be included in a particular document when the document is saved. The devices 432 may also be used to provide a selection between obtaining the digital signature trust context data as defined in a file (e.g., electronic content 424), or obtaining the digital signature trust context data as received from a graphical user interface (e.g., displayed on the output device 428). Thus, many embodiments may be realized.

For example, a machine 414 may form part of a system 400 comprising one or more processors 404 and a processor-implemented document processing module (e.g., as part of the rendering module 406) to access digital signature trust context data and obtain a previously-stored version number in a document file that includes document content data, digital signature data, and the digital signature trust context data. The previously-stored version number may correspond to that of the trust settings file existing at the time the document file was signed.

The system 400 may further include a processor-implemented digital signature processing module 412 to compare the current trusted version number obtained from the trust settings file with the previously-stored version number, and to indicate the previously-stored version number is not current when the previously-stored version number is not greater than or equal to the trusted version number. The signature processing module may be included in the machine 414 (e.g., operating as a server device), or the apparatus 440 (e.g., operating as a client device).

A page descriptive format application, such as a portable document format application, including the ADOBE® ACROBAT® application program, may be used to access the digital signature trust context data. Thus, the document processing module may comprise a page descriptive format processing module PDFM. The system 400 may operate to notify a user with a visible message when the version number stored in the document being processed is not current. Thus, the system 400 may comprise an output device 428 that includes a display to display a message 444 when the previously-stored version number is not current.

In some embodiments, a system 400 may comprise one or more of the machines 414, perhaps further including an apparatus 430. The apparatus 430 may comprise a server device or a client device. Thus, a system 400 may comprise a machine 414 in the form of a server device, and one or more client devices (in the form of an apparatus 430 and/or 440) communicatively coupled to the machine 414. A network 448 may be used to couple one or more components of the system 400 together, including the machine 414, the apparatus 430, and the apparatus 440.

Referring now to FIGS. 1 and 4, it can be seen that in some embodiments, the system 400 may comprise a means (e.g., the machine 414) for accessing electronic content 424 comprising a document file (e.g., file 140 of FIG. 1) including document content data, digital signature data, and digital signature trust context data including a previously-stored version number. The system 400 may further comprise a means (e.g., processors 404) for executing instructions included in a document processing application (e.g., as part of rendering module 406) to access the digital signature trust context data and to obtain a trusted version number from a digital signature trust settings file distinct from the document file. The system 400 may further comprise a means (e.g., module 412) for comparing the trusted version number with the previously-stored version number. The system 400 may further comprise a means (e.g., rendering module 406 and/or GUI module 408) for indicating, on an electronic display 428, the previously-stored version number is not current when the previously-stored version number is not greater than or equal to the trusted version number.

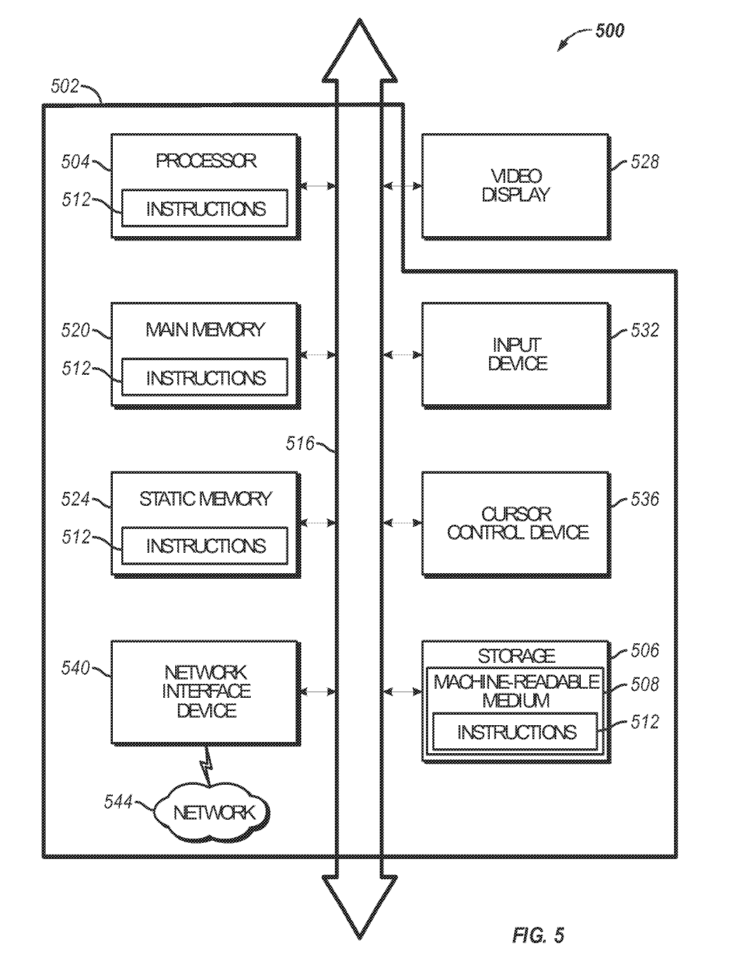

FIG. 5 is a block diagram of an article 500 of manufacture, including a specific machine 502, according to various embodiments. Upon reading and comprehending the content of this disclosure, one of ordinary skill in the art will understand the manner in which a software program can be launched from a computer-readable medium in a computer-based system to execute the functions defined in the software program. One of ordinary skill in the art will further understand the various programming languages that may be employed to create one or more software programs designed to implement and perform the methods disclosed herein. The programs may be structured in an object-orientated format using an object-oriented language such as Java or C++. Alternatively, the programs can be structured in a procedure-orientated format using a procedural language, such as assembly or C. The software components may communicate using any of a number of mechanisms well known to those of ordinary skill in the art, such as application program interfaces or interprocess communication techniques, including remote procedure calls. The teachings of various embodiments are not limited to any particular programming language or environment.

Thus, other embodiments may be realized. For example, an article 500 of manufacture, such as a computer, a memory system, a magnetic or optical disk, some other storage device, and/or any type of electronic device or system may include one or more processors 504 coupled to a machine-readable medium 508 such as a memory (e.g., removable storage media, as well as any memory including an electrical, optical, or electromagnetic conductor) having instructions 512 stored thereon (e.g., computer program instructions), which when executed by the one or more processors 504 result in the machine 502 performing any of the actions described with respect to the methods above.

The machine 502 may take the form of a computer system having a processor 504 coupled to a number of components directly, and/or using a bus 516. Thus, the machine 502 may be similar to or identical to the device 120 of FIG. 1, or the system 400, the machine 414, or the apparatus 430, 440 shown in FIG. 4.

Turning now to FIG. 5, it can be seen that the components of the machine 502 may include main memory 520, static or non-volatile memory 524, and mass storage 506. Other components coupled to the processor 504 may include an output device 528, such as a video display, an input device 532, such as a keyboard, and a cursor control device 536, such as a mouse. A network interface device 540 to couple the processor 504 and other components to a network 544 may also be coupled to the bus 516. The instructions 512 may further be transmitted or received over the network 544 via the network interface device 540 (shown here as separate from the output device 528 of FIG. 5) utilizing any one of a number of well-known transfer protocols (e.g., the HyperText Transfer Protocol). Any of these elements coupled to the bus 516 may be absent, present singly, or present in plural numbers, depending on the specific embodiment to be realized.

The processor 504, the memories 520, 524, and the storage device 506 may each include instructions 512 which, when executed, cause the machine 502 to perform any one or more of the methods described herein. For example, some embodiments may comprise a machine-readable medium having instructions stored therein for causing a machine to implement a method that comprises any of the activities described and shown with respect to FIGS. 3 and 4.

In some embodiments, the machine 502 operates as a standalone device or may be connected (e.g., networked) to other machines. In a networked environment, the machine 502 may operate in the capacity of a server or a client machine in server-client network environment, or as a peer machine in a peer-to-peer (or distributed) network environment. The machine 502 may comprise a personal computer (PC), a tablet PC, a set-top box (STB), a PDA, a cellular telephone, a web appliance, a network router, switch or bridge, or any machine capable of executing a set of instructions (sequential or otherwise) that specify actions to be taken by that machine. Further, while only a single machine 502 is illustrated, the term “machine” shall also be taken to include any collection of machines that individually or jointly execute a set (or multiple sets) of instructions to perform any one or more of the methodologies discussed herein.

While the machine-readable medium 508 is shown as a single medium, the term “machine-readable medium” should be taken to include a single medium or multiple media (e.g., a centralized or distributed database, and/or associated caches and servers, and or a variety of storage media, such as the processor 504 registers, memories 520, 524, and the storage device 506) that store the one or more sets of instructions 512. The term “machine-readable medium” shall also be taken to include any medium that is capable of storing, encoding or carrying a set of instructions for execution by the machine and that cause the machine 502 to perform any one or more of the methodologies of the present invention, or that is capable of storing, encoding or carrying data structures utilized by or associated with such a set of instructions. The terms “machine-readable medium” or “computer-readable medium” shall accordingly be taken to include tangible media, such as solid-state memories and optical and magnetic media.

Implementing the apparatus, systems, and methods of the various embodiments may provide security settings that are updated automatically according to a specified version number. These updates can be obtained from a specified, trusted source. Improved document processing security may result.

Certain applications or processes are described herein as including a number of modules or mechanisms. A module or a mechanism may be a unit of distinct functionality that can provide information to, and receive information from, other modules. Accordingly, the described modules may be regarded as being communicatively coupled. Modules may also initiate communication with input or output devices, and can operate on a resource (e.g., a collection of information). Modules may include hardware circuitry, optical components, single or multi-processor circuits, memory circuits, software program modules and objects, firmware, and combinations thereof, as appropriate for particular implementations of various embodiments. The term “module” includes an identifiable portion of code, data, or a computational object to achieve a particular function, operation, processing, or procedure.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).).

Embodiments may, for example, be implemented as a stand-alone application (e.g., without any network capabilities), a client-server application or a peer-to-peer (or distributed) application. Embodiments may also, for example, be deployed by SaaS, Application Service Provider (ASP), or utility computing providers, in addition to being sold or licensed via traditional channels.

In this Detailed Description, numerous specific details are set forth to provide a thorough understanding of claimed subject matter. However, it will be understood by those skilled in the art that claimed subject matter may be practiced without these specific details. In other instances, methods, apparatus, or systems that would be known by one of ordinary skill have not been described in detail so as not to obscure the claimed subject matter.

Some portions of this disclosure are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is here, and generally, considered to be a self-consistent sequence of operations or similar processing leading to a desired result.

In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates and transforms data represented as physical electronic or magnetic quantities within memories, registers, or other information storage devices, transmission devices, or display devices of the computing platform.

Thus, for example, some embodiments may include a method that comprises executing instructions on a computing platform to receive binary digital electronic signals representing electronic content. The activities of the method may further include executing instructions on the computing platform to store at least some of the binary digital electronic signals representing the electronic content in a memory location of the computing platform. Still further activities may comprise executing instructions on the computing platform to graphically display some of the binary digital electronic signals representing the electronic content on an electronic display device coupled to the computing platform, wherein the electronic content comprises a document file including document content data, digital signature data, and digital signature trust context data.

Additional activities may include executing instructions included in a document processing application on the computing platform to access the digital signature trust context data and to obtain a trusted version number from a digital signature trust settings file, executing instructions on the computing platform to compare the trusted version number with a previously-stored version number included in the digital signature trust context data, and executing instructions on the computing platform to indicate the previously-stored version number is not current when the previously-stored version number is not greater than or equal to the trusted version number.

Although embodiments of the invention have been described with reference to specific example embodiments, it will be evident that various modifications and changes may be made to these embodiments without departing from the broader scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those of ordinary skill in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of ordinary skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

1. A computer-implemented method, comprising:
accessing electronic content comprising a document file including document content data, digital signature data, and digital signature trust context data that includes a previously-stored version number of a digital signature trust setting file at a time the document file was signed, the digital signature trust setting file including specifications to a chain of trust used to reach a trusted root certificate;
executing instructions included in a document processing application to access the digital signature trust context data embedded within the document file and to obtain a trusted version number of the digital signature trust settings file that is distinct from the document file;
comparing the trusted version number of the digital signature trust setting file with the previously-stored version number of the digital signature trust setting file from the document file; and
indicating, on an electronic display, the previously-stored version number of the digital signature trust setting file is not current in response to the previously-stored version number of the digital signature trust setting file being not greater than or equal to the trusted version number of the digital signature trust setting file.

2. The method of claim 1, wherein the digital signature trust context data further comprises:
directions to locate the digital signature trust settings file.

3. The method of claim 2, wherein the directions include a universal resource locator.

4. The method of claim 1, further comprising:
storing the digital signature data as a hash of a public certificate used to sign the document file.

5. The method of claim 1, wherein the executing comprises:
decoding the previously-stored version number using a public key.

6. The method of claim 1, wherein the executing comprises:
executing the instructions independently of coupling a current processing entity to a network.

7. The method of claim 1, wherein the executing comprises:
determining that the digital signature trust context data has been corrupted.

8. The method of claim 1, further comprising:
selectively locking access to the document file when the digital signature trust context data has been corrupted.

9. The method of claim 1, further comprising:
receiving new trust settings information from a third party; and
incorporating the new trust settings information in the digital signature trust settings file.

10. The method of claim 1, wherein the indicating comprises:
indicating the previously-stored version number is not current when the previously-stored version number is not exactly equal to the trusted version number.

11. The method of claim 1, wherein the indicating comprises:
publishing an error message; and
locking access to the document file.

12. A non-transitory computer-readable medium having instructions stored therein, which when executed, cause a computer to implement operations comprising:
accessing electronic content comprising a document file including document content data, digital signature data, and digital signature trust context data that includes a previously-stored version number of a digital signature trust setting file at a time the document file was signed, the digital signature trust setting file including specifications to a chain of trust used to reach a trusted root certificate;
executing instructions included in a document processing application to access the digital signature trust context data embedded within the document file and to obtain a trusted version number of the digital signature trust settings file that is distinct from the document file;
comparing the trusted version number of the digital signature trust setting file with the previously-stored version number of the digital signature trust setting file from the document file; and
indicating the previously-stored version number of the digital signature trust setting file is not current in response to the previously-stored version number of the digital signature trust setting file being not greater than or equal to the trusted version number of the digital signature trust setting file.

13. The medium of claim 12, wherein the operations further comprise:
verifying trust for a plurality of digital signatures applied to the document file, wherein the plurality of digital signatures correspond to a plurality of security contexts, including the digital signature trust context.

14. The medium of claim 12, wherein the operations further comprise:
receiving at least some of the digital signature trust context data from a graphical user interface.

15. A system, comprising:
at least one processor of a machine;
a processor-implemented document processing module to access digital signature trust context data and obtain a previously-stored version number of a digital signature trust setting file at a time the document file was signed from the digital signature trust context data of a document file that includes document content data, digital signature data, and the digital signature trust context data, the digital signature trust setting file including specifications to a chain of trust used to reach a trusted root certificate; and
a processor-implemented digital signature processing module to compare a trusted version number of the digital signature trust settings file with the previously-stored version number of the digital signature trust setting file from the document file, and to indicate the previously-stored version number of the digital signature trust setting file is not current in response to the previously-stored version number of the digital signature trust setting file being not greater than or equal to the trusted version number of the digital signature trust setting file.

16. The system of claim 15, wherein the document processing module comprises a page descriptive format processing module.

17. The system of claim 15, further comprising:
a server device including the document processing module.

18. The system of claim 15, further comprising:
a client device including the digital signature processing module.

19. The system of claim 15, further comprising:
a display to display a message when the previously-stored version number is not current.

20. The system of claim 15, further comprising:
a user input device to provide a selection between obtaining the digital signature trust context data as defined in a file, or obtaining the digital signature trust context data as received from a graphical user interface.
